(19) United States
(12) Patent Application Publication
(10) Pub. No.: US 2023/0311875 A1
(43) Pub. Date: Oct. 5, 2023

(54) CONTROL DEVICE, METHOD FOR OPERATING CONTROL DEVICE, AND NON-TRANSITORY COMPUTER-READABLE STORAGE MEDIUM

(71) Applicant: HONDA MOTOR CO., LTD., Tokyo (JP)

(72) Inventors: Haruhiko NISHIGUCHI, Wako-shi (JP); Daichi KATO, Wako-shi (JP)

(21) Appl. No.: 18/109,947

(22) Filed: Feb. 15, 2023

(30) Foreign Application Priority Data
Mar. 30, 2022 (JP) 2022-056983

(51) Int. Cl. B60W 30/16; B60W 30/18

(52) U.S. Cl. CPC B60W 30/16; B60W 30/18163; B60W 2552/30; B60W 2720/10; B60W 2552/53; B60W 2556/40; B60W 2554/4041; B60W 2554/4042; B60W 2554/802; B60W 2552/05; B60W 2540/215

(57) ABSTRACT

A control device that controls a vehicle, the control device comprising: an obtaining unit configured to obtain peripheral information of the vehicle; a specifying unit configured to specify a travel path of the vehicle and a curved road ahead of the travel path of the vehicle on the basis of the peripheral information; a prediction unit configured to predict whether or not automatic lane change is performed on the curved road; and a control unit configured to control a speed of the vehicle on the basis of a prediction result of the prediction unit and a curvature of the curved road.

### CROSS-REFERENCE TO RELATED APPLICATION(S)

This application claims priority to and the benefit of Japanese Patent Application No. 2022-056983 filed on Mar. 30, 2022, the entire disclosure of which is incorporated herein by reference.

### BACKGROUND OF THE INVENTION

### Field of the Invention

The present invention relates to a control device, a method for operating the control device, and a non-transitory computer-readable storage medium.

### Description of the Related Art

Japanese Patent Laid-Open No. 2009-274594 discloses that a speed limit at which a vehicle can safely turn on a curved road is calculated from a curvature of the curved road ahead, and lane change assistance is prohibited when a speed of a self-vehicle exceeds the speed limit.

Here, when automatic lane change is performed during traveling on the curved road, lateral acceleration larger than lateral acceleration predicted from the curvature of the curved road may be applied depending on a direction of lane change. In that case, it is necessary to greatly decelerate. On the other hand, if the vehicle is uniformly decelerated greatly in consideration of the automatic lane change during traveling on the curved road, the vehicle may be decelerated excessively in relation to surrounding traffic flow. However, a technique described in Japanese Patent Laid-Open No. 2009-274594 has a problem that it is difficult to perform adaptive speed control during traveling on the curved road.

### SUMMARY OF THE INVENTION

The present invention has been made in view of the above problems, and provides a technique for performing the adaptive speed control during traveling on the curved road, and suppressing reduction in smoothness of traffic while improving traffic safety.

According to one aspect of the present invention, there is provided a control device that controls a vehicle, the control device comprising: an obtaining unit configured to obtain peripheral information of the vehicle; a specifying unit configured to specify a travel path of the vehicle and a curved road ahead of the travel path of the vehicle on the basis of the peripheral information; a prediction unit configured to predict whether or not automatic lane change is performed on the curved road; and a control unit configured to control a speed of the vehicle on the basis of a prediction result of the prediction unit and a curvature of the curved road.

Further features of the present invention will become apparent from the following description of exemplary embodiments with reference to the attached drawings.

### BRIEF DESCRIPTION OF THE DRAWINGS

FIG. 1 is a block diagram of a vehicle and a control device;

FIG. 2 is an explanatory diagram illustrating types of driver assist modes and an outline thereof;

FIG. 3 is an explanatory diagram illustrating an example of switching the driver assist modes;

FIGS. 4A to 4C are flowcharts illustrating exemplary processing performed by the control device of FIG. 1;

FIG. 5 is a flowchart illustrating exemplary processing performed by the control device of FIG. 1;

FIG. 6 is a flowchart illustrating exemplary processing performed by the control device of FIG. 1;

FIG. 7 is a flowchart illustrating an example of prediction processing performed by the control device of FIG. 1;

FIG. 8 is a flowchart illustrating an example of speed control processing performed by the control device of FIG. 1;

FIG. 9 is a flowchart illustrating another example of the speed control processing performed by the control device of FIG. 1;

FIG. 10 is an explanatory diagram of a control example when the vehicle catches up with a preceding vehicle on a curved road and automatic lane change is performed on the curved road;

FIG. 11 is an explanatory diagram of a control example when there is no preceding vehicle and the automatic lane change is not performed on the curved road;

FIG. 12 is an explanatory diagram of a control example when the automatic lane change for overtaking is performed before entering the curved road, and the vehicle enters the curved road in that state: and

FIG. 13 is an explanatory diagram of a control example when a course is changed to a branch road after leaving the curved road.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Control Device and Application Example Thereof

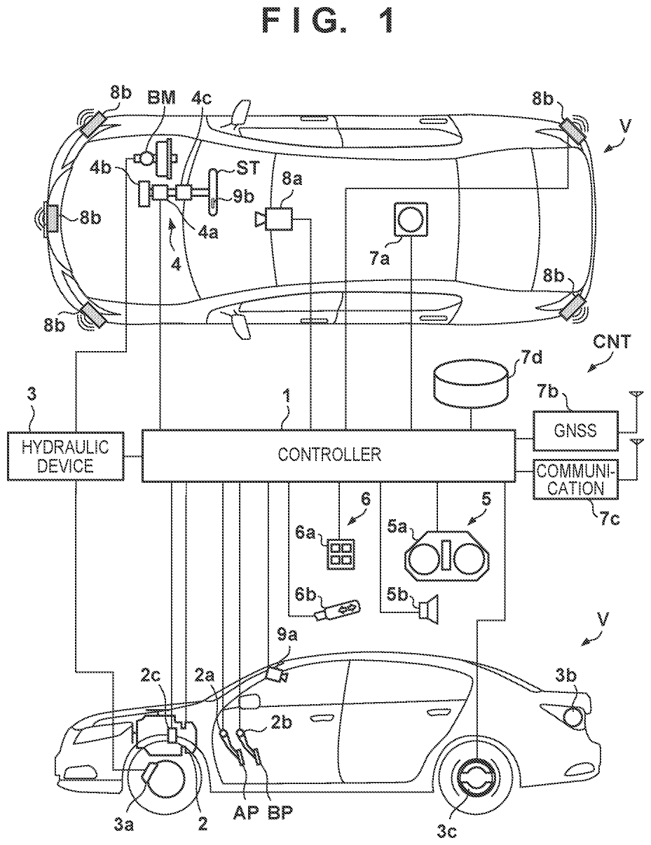

FIG. 1 is a block diagram of a control device CNT according to an embodiment of the present invention and a schematic diagram of a vehicle V as an application example thereof. In FIG. 1, an outline of the vehicle V is illustrated in a plan view and in a side view. The vehicle V of the present embodiment is, as an example, a sedan-type four-wheeled passenger car, and can be, for example, a parallel hybrid vehicle. Note that the vehicle V is not limited to the four-wheeled passenger car, and may be a straddle type vehicle (motorcycle or automatic three-wheeled vehicle) or a large vehicle such as a truck or a bus.

The control device CNT includes a controller 1 that is an electronic circuit that performs control of the vehicle V including driving assistance of the vehicle V. The controller 1 includes a plurality of electronic control units (ECUs). The ECU is, for example, provided for each function of the control device CNT. Each ECU includes a processor represented by a central processing unit (CPU), a storage device such as a semiconductor memory, an interface with an external device, and the like. The storage device stores a program to be executed by the processor, data to be used for processing by the processor, and the like. The interface includes an input/output interface and a communication interface. Each ECU may include a plurality of processors, storage devices, and interfaces. The program stored in the storage device may be stored in the storage device by being installed in the control device CNT using a non-transitory computer-readable storage medium such as a CD-ROM.

The controller 1 controls driving (acceleration) of the vehicle V by controlling a power unit (power plant) 2. The power unit 2 is a travel driving unit that outputs driving force for rotating driving wheels of the vehicle V, and can include an internal combustion engine, a motor, and an automatic transmission. The motor can be used as a drive source for accelerating the vehicle V, and can also be used as a generator at the time of deceleration or the like (regenerative braking).

In the case of the present embodiment, the controller 1 controls an output of the internal combustion engine or the motor or switches a gear ratio of the automatic transmission in accordance with a driving operation of a driver detected by an operation detection sensor 2a provided on an accelerator pedal AP or an operation detection sensor 2b provided on a brake pedal BP, a vehicle speed of the vehicle V detected by a rotation speed sensor 2c, or the like. Note that the automatic transmission is provided with the rotation speed sensor 2c that detects a rotation speed of an output shaft of the automatic transmission as a sensor that detects a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A braking operation by the driver on a brake pedal BP is converted into hydraulic pressure in a brake master cylinder BM to be transmitted to the hydraulic device 3. The hydraulic device 3 is an actuator capable of controlling hydraulic pressure of a hydraulic oil supplied to a brake device 3a (for example, a disc brake device) provided on each of four wheels on the basis of the hydraulic pressure transmitted from the brake master cylinder BM.

The controller 1 can control braking of the vehicle V by performing drive control of an electromagnetic valve or the like included in the hydraulic device 3. In addition, the controller 1 can also configure an electric servo brake system by controlling distribution of a braking force by the brake device 3a and a braking force by the regenerative braking of the motor included in the power unit 2. The controller 1 may turn on a brake lamp 3b at the time of braking.

The controller 1 controls steering of the vehicle V by controlling an electric power steering device 4. The electric power steering device 4 includes a mechanism that steers front wheels in response to the driving operation (steering operation) of the driver on a steering wheel ST. The electric power steering device 4 includes a drive unit 4a that exerts driving force (may be referred to as a steering assist torque) for assisting the steering operation or automatically steering the front wheels of the vehicle V. The drive unit 4a includes a motor as a drive source. In addition, the electric power steering device 4 includes a steering angle sensor 4b that detects a steering angle, a torque sensor 4c that detects a steering torque (referred to as a steering load torque and is distinguished from the steering assist torque) borne by the driver, and the like.

The controller 1 controls an electric parking brake device 3c provided on a rear wheel of the vehicle V. The electric parking brake device 3c includes a mechanism for locking the rear wheel. The controller 1 can control locking and unlocking of the rear wheel by the electric parking brake device 3c.

The controller 1 controls an information output device 5 that notifies information to the inside of the vehicle. The information output device 5 includes, for example, a display device 5a that notifies the driver of the information by an image and/or a voice output device 5b that notifies the driver of the information by a voice. The display device 5a includes, for example, a display device provided on an instrument panel or a display device provided on the steering wheel ST. In addition, the display device 5a may include a head-up display. The information output device 5 may notify an occupant of the information by vibration or light.

The controller 1 receives an instruction input from the occupant (for example, the driver) via an input device 6. The input device 6 is disposed at a position operable by the driver, and includes, for example, a switch group 6a for the driver to instruct the vehicle V and/or a direction indicator lever 6b for operating a direction indicator (blinker).

The controller 1 recognizes and determines a current position and a course (an attitude) of the vehicle V. In the case of the present embodiment, the vehicle V is provided with a gyro sensor 7a, a global navigation satellite system (GNSS) sensor 7b, and a communication device 7c. The gyro sensor 7a detects a rotational motion (yaw rate) of the vehicle V. The GNSS sensor 7b detects the current position of the vehicle V. In addition, the communication device 7c performs wireless communication with a server that provides map information and traffic information, and acquires these pieces of information. In the case of the present embodiment, the controller 1 determines the course of the vehicle V on the basis of detection results of the gyro sensor 7a and the GNSS sensor 7b, and sequentially acquires map information on the course from the server via the communication device 7c to store the map information in database 7d (the storage device). Note that the vehicle V may be provided with another sensor for detecting the state of the vehicle V, such as an acceleration sensor for detecting acceleration of the vehicle V.

The controller 1 performs driving assistance of the vehicle V on the basis of detection results of various detection units provided in the vehicle V. The vehicle V is provided with surroundings detection units 8a and 8b which are external sensors that detect the outside (surrounding conditions) of the vehicle V, and vehicle interior detection units 9a and 9b which are vehicle interior sensors that detect conditions inside the vehicle (a state of the occupant (particularly the driver)). The controller 1 can grasp the surrounding conditions of the vehicle V on the basis of the detection results of the surroundings detection units 8a and 8b, and perform driving assistance according to the surrounding conditions. In addition, the controller 1 can determine whether the driver is performing a predetermined operational duty imposed on the driver when performing driving assistance on the basis of the detection results of the vehicle interior detection units 9a and 9b.

The surroundings detection unit 8a is an imaging device (hereinafter, may be referred to as a front camera 8a) that captures an image of the front of the vehicle V, and is attached to, for example, the vehicle interior side of a windshield at the front of a roof of the vehicle V. The controller 1 can extract a contour of a target or a lane marking (such as a white line) on a road by analyzing the image captured by the front camera 8a.

The surroundings detection unit 8b is a millimeter wave radar (hereinafter, may be referred to as a radar 8b), detects the target around the vehicle V using radio waves, and detects (measures) a distance to the target and a direction (an azimuth) of the target with respect to the vehicle V. In the example illustrated in FIG. 1, five radars 8b are provided, including one at the center of the front portion of the vehicle V, one at each of the left and right corner portions of the front portion, and one at each of the left and right corner portions of the rear portion.

Note that the surroundings detection unit provided in the vehicle V is not limited to the above configuration, and the number of cameras and the number of radars may be changed, or a light detection and ranging (LIDAR) for detecting the target around the vehicle V may be provided.

The vehicle interior detection unit 9a is an imaging device (hereinafter, may be referred to as an in-vehicle camera 9a) that captures an image of the inside of the vehicle, and is attached to, for example, the vehicle interior side at the front of the roof of the vehicle V. In the case of the present embodiment, the in-vehicle camera 9a is a driver monitor camera that captures an image of the driver (for example, eyes and a face of the driver). The controller 1 can determine a direction of line of sight or the face of the driver by analyzing an image (a face image of the driver) captured by the in-vehicle camera 9a.

The vehicle interior detection unit 9b is a grip sensor (hereinafter, may be referred to as a grip sensor 9b) that detects grip of the steering wheel ST by the driver, and is provided, for example, in at least a part of the steering wheel ST. Note that as the vehicle interior detection unit, the torque sensor 4c that detects the steering torque of the driver may be used.

### Example of Driving Assistance Control

Examples of the driving assistance of the vehicle V for the driver include acceleration/deceleration assistance, lane keeping assistance, and lane change assistance. The acceleration/deceleration assistance is driving assistance (adaptive cruise control (ACC)) in which the controller 1 automatically controls the acceleration/deceleration of the vehicle V within a predetermined vehicle speed by automatically controlling the power unit 2 and the hydraulic device 3 on the basis of the detection result of the surroundings detection unit 8 and the map information. In the ACC, when there is a preceding vehicle, the acceleration/deceleration of the vehicle V can be performed so as to maintain an inter-vehicle distance from the preceding vehicle. The ACC reduces an operation burden of an acceleration/deceleration operation (an operation on the accelerator pedal AP or the brake pedal BP) by the driver.

The lane keeping assistance is driving assistance (lane keeping assist system (LKAS)) in which the controller 1 keeps the vehicle V inside a lane by automatically controlling the electric power steering device 4 on the basis of the detection result of the surroundings detection unit 8 and the map information. The LKAS reduces an operation burden of the steering operation (operation on the steering wheel ST) by the driver while the vehicle V is traveling straight.

The lane change assistance is driving assistance (advanced lane change (ALC), active lane change assist (ALCA)) in which the controller 1 changes a travel lane of the vehicle V to an adjacent lane by automatically controlling the power unit 2, the hydraulic device 3, and the electric power steering device 4 on the basis of the detection result of the surroundings detection unit 8 and the map information. The ALC is lane change assistance base on a system request (request from the control device), and the ALCA is lane change assistance based on an occupant request. An example of the system request is a case where a navigation system that provides route guidance to a destination of the vehicle V requests a lane change of the vehicle V. When making the occupant request, the driver instructs the lane change by operating the input device (for example, the direction indicator lever 6b). The ALC or the ALCA reduces the operation burden of the acceleration/deceleration operation and the steering operation of the vehicle V by the driver at the time of lane change.

Note that other examples of driving assistance control may include a collision reduction brake that assists collision avoidance with the target (for example, a pedestrian, another vehicle, or an obstacle) on the road by controlling the hydraulic device 3, an ABS function, traction control, and/or posture control of the vehicle V.

<Driver Assist Mode>

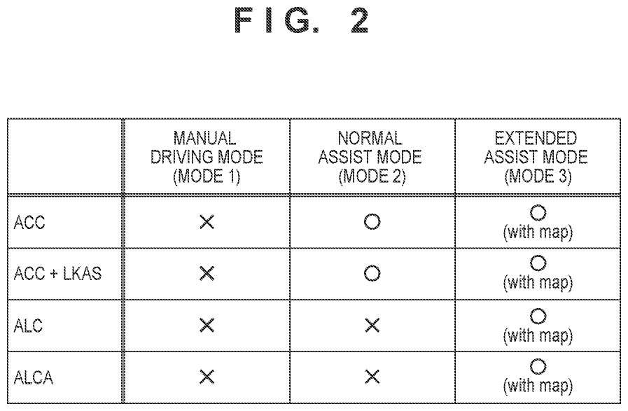

In the case of the present embodiment, one mode is selectively set among a plurality of modes having different driving assistance contents. FIG. 2 is an explanatory diagram of thereof. Here, relationships between three types of modes 1 to 3 and execution feasibility of the ACC, the LKAS, the ALC, and the ALCA are illustrated. The driving assistance content in each mode 1 to 3 is not limited to the ACC, the LKAS, the ALC, or the ALCA, and may include other driving assistance content. In addition, only one of the ALC and the ALCA may be used.

The mode 1 is a manual driving mode in which none of the ACC, the LKAS, the ALC, and the ALCA is performed, and is a mode based on a manual driving operation of the driver. This mode is a mode set first when the vehicle V is activated.

The mode 2 and the mode 3 are modes set on condition that the occupant makes a driving assistance instruction in the mode 1. The mode 2 is a normal assist mode that can be performed by the ACC and the LKAS. In the mode 2, the ALC and the ALCA are not performed.

The mode 3 is an extended assist mode in which all of the ACC, the LKAS, the ALC, and the ALCA can be performed. The mode 3 is a mode on the assumption that the controller 1 has obtained high-precision map information including information on a road (travel path) on which the vehicle V travels. The high-precision map information is map information having more accurate information about road information than map information (may be referred to as normal map information) used for the route guidance to the destination. Specifically, at least position information in the lane is included. This can be used to control the position of the vehicle V in the vehicle width direction. A high-precision map may be used that further includes information on a detailed shape of the road, such as presence or absence of a curve, curvature, increase or decrease of the lane, and gradient. The high-precision map information is, for example, prepared for each region or road section, and there can be a region or road section for which the high-precision map information is not provided.

In the mode 3, the lane change assistance (ALC and ALCA) is performed using the high-precision map information. By utilizing the position information in the lane included in the high-precision map information and the current position of the vehicle V detected by the GNSS sensor 7b, it is possible to perform highly reliable and smooth lane change assistance while recognizing other vehicles in the vicinity from external detection results of the detection units 8a and 8b. The lane change assistance can be performed without using the high-precision map information, but if there is a difference in behavior of the vehicle V at the time of lane change assistance between a case where the high-precision map information is used and a case where the high-precision map information is not used, the driver may feel discomfort. In the present embodiment, by performing the lane change assistance on the premise of obtaining the high-precision map information, it is possible to prevent such discomfort from being given to the occupant and to provide the occupant with highly reliable lane change assistance.

Note that in the present embodiment, a travel environment on a specific road has been described as an example of a travel scene of the vehicle V, but the present invention is not limited to this example, and can be applied to a case where highly accurate map information is not provided. For example, image information such as a past travel history of the vehicle V can also be used instead of the map information. For example, when matching between the image information such as the past travel history and an image captured by the front camera 8a is successful, it is possible to provide the driving assistance in the extended assist mode in a road environment in which the highly accurate map information is not provided. Thus, even in the road environment in which the highly accurate map information is not provided, it is possible to provide the driving assistance in the extended assist mode in the same manner as on the specific road.

Both the mode 2 and the mode 3 are modes capable of performing the ACC and the LKAS, but in the mode 3, the ACC and the LKAS using the high-precision map information can be performed. In terms of using the high-precision map information, the ACC and the LKAS in the mode 3 are respectively represented as the ACC with map and the LKAS with map. The controller 1 can take the road information of travel destination of the vehicle V from the high-precision map information in advance to perform the acceleration/deceleration of the vehicle V and position control in a left-and-right direction, and can provide the occupant with more reliable and smooth ACC and LKAS.

Note that in the present embodiment, in both the mode 2 and the mode 3, the driver is requested to perform predetermined operational duties such as peripheral monitoring and gripping of the steering wheel. When it is determined that the driver does not perform the predetermined operational duties on the basis of the detection results of the vehicle interior detection units 9a and 9b, the information output device 5 performs notification (warning) for prompting the driver to perform the predetermined operational duties.

### Transition Example of Mode Setting

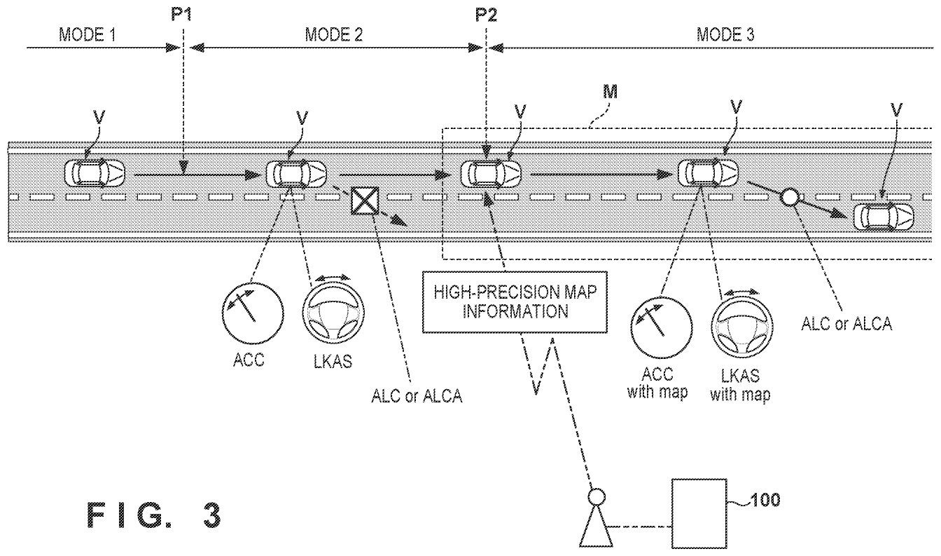

FIG. 3 is a diagram illustrating a transition example of the driver assist mode. While the vehicle V is traveling in the mode 1, when the driver makes the driving assistance instruction via the input device 6 at a position P1, the mode 2 is set. The controller 1 performs ACC control and LKAS control of the vehicle V. As indicated by a cross mark in the figure, ALC control and ALCA control of the vehicle V are not performed. When the driver wishes to change lanes, the lane change is performed by the driver's own driving operation.

The road (travel path) on which the vehicle V travels is a road on which the high-precision map information is provided in a section M. The controller 1 obtains (receives) the high-precision map information of the section M from a map providing server 100 via a communication line by the communication device 7c at a position P2. Thus, the driver assist mode is switched from the mode 2 to the mode 3. The controller 1 performs the ACC control and the LKAS control using the high-precision map information. In addition, the ALC control or the ALCA control is performed in response to the system request or the occupant request as indicated by a circle mark in the figure.

<Exemplary Processing>

Exemplary processing performed by the processor of the ECU constituting the controller 1 will be described.

<Operation Duty Monitoring>

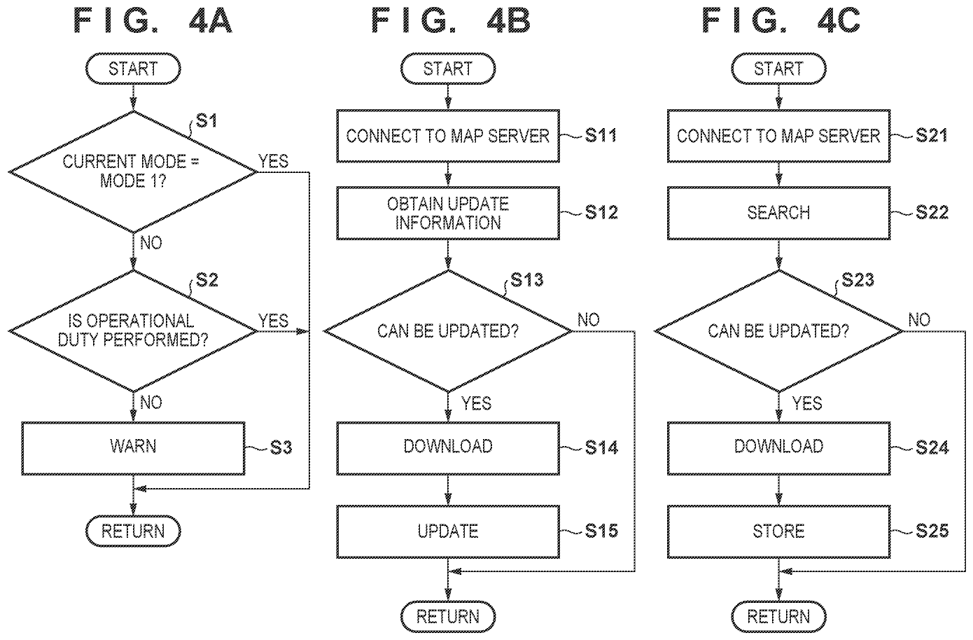

FIG. 4A is a flowchart illustrating exemplary processing performed by the ECU that monitors the operational duty of the driver, and the processing is periodically performed.

In S1, it is determined whether the current driver assist mode is the mode 1. If the current driver assist mode is the mode 1, the processing is ended, and if the current driver assist mode is the mode 2 or the mode 3, the process proceeds to S2. In S2, it is determined whether the driver performs the operational duty on the basis of the detection results of the detection units 9a and 9b. If it is determined that the operational duty is performed, the processing is ended, and if it is determined that the operational duty is not performed, the process proceeds to S3. In S3, the information output device 5 warns the driver.

<Management of High-Precision Map Information>

FIGS. 4B and 4C are flowcharts illustrating exemplary processing performed by the ECU that manages the high-precision map information. FIG. 4B illustrates exemplary processing related to update (data update) of the obtained high-precision map information, and the processing is performed, for example, when the vehicle V is started.

In S11, the communication device 7c connects to the map providing server 100 and starts communication with the map providing server 100. In S12, update information (latest version information) of each piece of the high-precision map information is obtained (received) from the map providing server 100. In S13, it is determined whether the obtained high-precision map information can be updated to the latest version. In this determination, it is determined whether the latest version of the obtained high-precision map information is provided and there is a qualification (for example, a provision contract of the map, charging, and the like) to receive the provision. When the information can be updated, the process proceeds to S14, and the updated map data of the latest version of the high-precision map information is downloaded from the map providing server 100. In S15, the obtained high-precision map information is updated by the updated map data obtained in S14. Thus, the high-precision map information can be maintained in the latest state.

FIG. 4C is the processing while the vehicle V is traveling, and is processing performed when the vehicle V is traveling on a road for which the high-precision map information is not obtained or when the vehicle V is about to enter the road for which the high-precision map information is not obtained.

In S21, the communication device 7c connects to the map providing server 100 and starts the communication with the map providing server 100. In S22, the map providing server 100 is requested to search for the high-precision map information including information on the travel path of the vehicle V or a road on which the vehicle V is scheduled to travel, and a response is obtained. In S23, it is determined whether it is possible to obtain the high-precision map information including the information on the travel path of the vehicle V or the road on which the vehicle V is scheduled to travel. In this determination, it is determined whether the high-precision map information requested to be searched has been provided and there is the qualification (for example, the provision contract of the map, charging, and the like) to receive the provision. When the information can be obtained, the process proceeds to S24, and the high-precision map information requested to be searched is downloaded from the map providing server 100. In S25, the high-precision map information obtained in S24 is stored in the database 7d. This makes it possible to set the mode 3.

<Mode Setting>

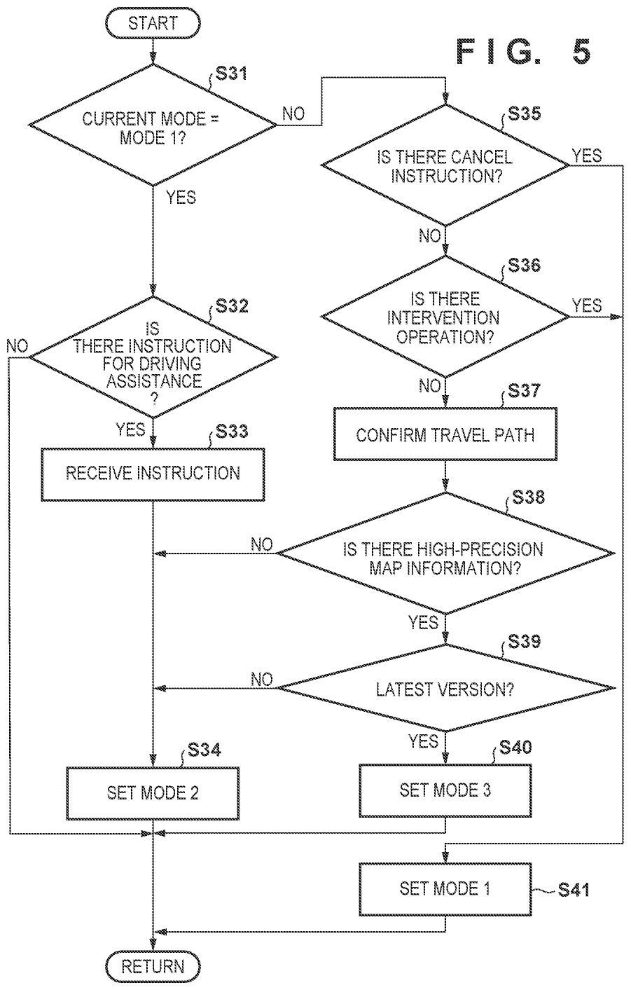

FIG. 5 is a flowchart illustrating exemplary processing performed by the ECU that sets the driver assist mode, and the processing is periodically performed. In S31, it is determined whether the current mode is the mode 1. If the current mode is the mode 1, the process proceeds to S32, and if the current mode is the mode 2 or the mode 3, the process proceeds to S35.

In S32, it is determined whether a start instruction for driving assistance has been made from the driver. The driver can make the start instruction via the input device 6. When an instruction operation is performed on the input device 6, the start instruction for driving assistance is received in S33, and the mode 2 is set in S34. In S35, it is determined whether a cancel instruction for driving assistance has been made. The driver can make the cancel instruction via the input device 6. If the cancel instruction has been made, the mode 1 is set in S41, and if the cancel instruction has not been made, the process proceeds to S36.

In S36, it is determined whether an intervention operation has been performed by the driver. The intervention operation is the acceleration/deceleration operation and the steering operation of the driver during driving assistance, and is detected by the operation detection sensors 2a and 2b, the steering angle sensor 4b, and the torque sensor 4c. When such an operation reaches a certain amount of time or a certain amount of operation, it is assumed that the driver intends manual driving, the mode 1 is set in S41, and control is performed so that driving of the vehicle V is entrusted to the driver. If there is no intervention operation, the process proceeds to S37.

In S37, the travel path of the vehicle Vis specified on the basis of a detection result of the GNSS sensor 7b and the normal map information or the high-precision map information. In S38, it is determined whether the high-precision map information including the information on the travel path specified in S37 has been obtained, and if the high-precision map information has not been obtained, the process proceeds to S34 and the mode 2 is set. When the high-precision map information has been obtained, the process proceeds to S39, and it is determined whether the high-precision map information is the latest version. Whether it is the latest version is determined on the basis of the update information obtained in S12 of FIG. 4B. If it is not the latest version, there is a possibility that quality of driving assistance in the mode 3 will be deteriorated, and thus the mode 2 is set in S34. If it is the latest version, the mode 3 is set in S40.

In the present embodiment, when the driving assistance instruction from the occupant is received in S33, unless the mode 1 is set, the mode 2 or the mode 3 is set without requiring the driving assistance instruction again. That is, the driving assistance instruction is a condition of the mode 1 to the mode 2, but is not a condition of the mode 2 to the mode 3.

Therefore, for example, after the mode 3 is set, there is a case where the mode 2 is set due to traveling on a road having no high-precision map information (S38 and S34), but when the high-precision map information is obtained after traveling in the mode 2, the mode 3 is set without requiring re-reception of the driving assistance instruction from the occupant (S38 and S40), and the ALC and the ALCA can be provided to the driver. Therefore, the driver is not required to repeatedly make the driving assistance instruction, and it is possible to prevent the instruction operation from giving a complicated feeling.

On the other hand, even if the mode 2 or the mode 3 is being set, if the intervention operation is performed, the mode 1 is set (S36 and S41). In this case, the driving assistance instruction is required again in order to set the mode 2 or the mode 3. It is possible to reliably confirm the driver's intention concerning provision of driving assistance.

<Control Processing of Lane Change Assistance>

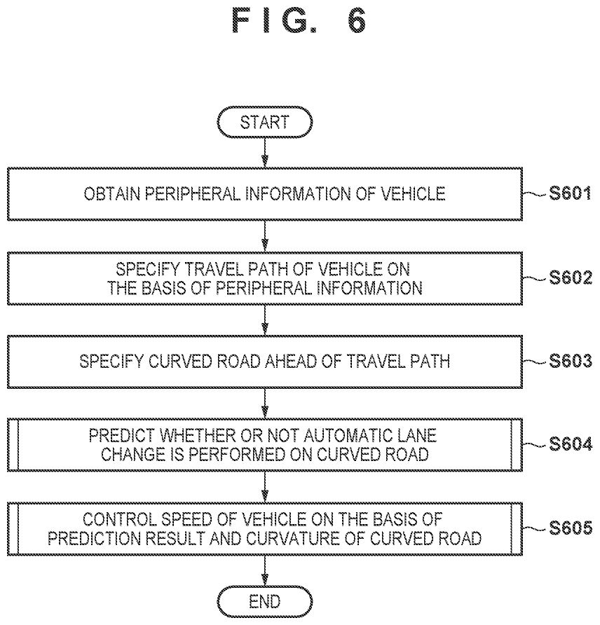

FIG. 6 is a flowchart illustrating exemplary processing of lane change assistance control performed by the ECU included in the controller 1. Note that this processing is processing that can be performed when the vehicle V is in the extended assist mode (mode 3) in which all of the ACC, the LKAS, the ALC, and the ALCA can be performed (when the high-precision map is used). This processing is repeatedly performed.

In S601, the ECU obtains peripheral information of the vehicle V using the surroundings detection units 8a and 8b which are external sensors that detect the outside (surrounding conditions) of the vehicle V. Note that the peripheral information is continuously obtained at all times. In S602, the ECU specifies the travel path of the vehicle V on the basis of the peripheral information obtained in S601.

In S603, the ECU specifies a curved road ahead of the travel path of the vehicle V specified in S602. When a travel path having a curvature of a predetermined value or more continues ahead of the travel path of the vehicle V, it can be specified as the curved road. The curvature of the curved road may be calculated from the peripheral information or may be obtained from the map information. Alternatively, they may be combined. When the curved road cannot be specified, subsequent processing is skipped and the processing is ended.

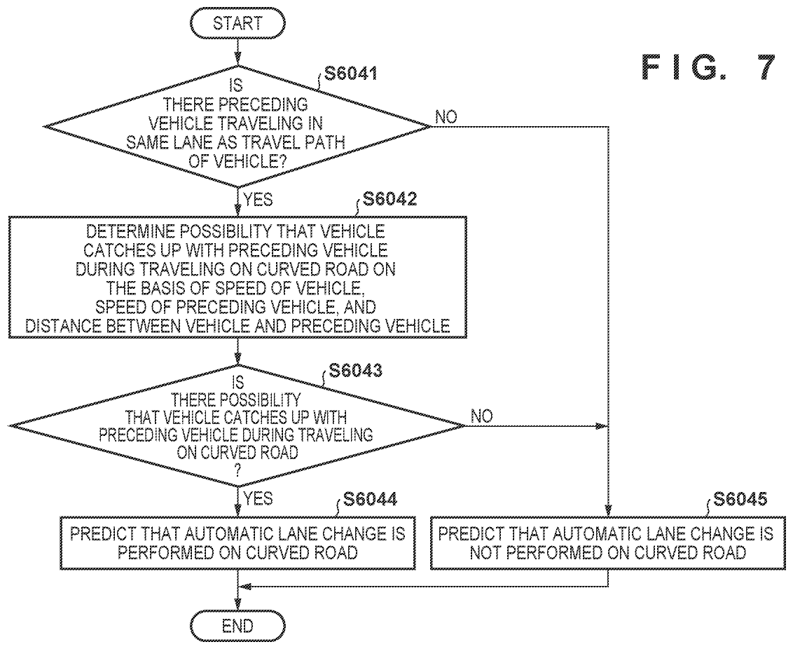

In S604, the ECU predicts whether or not the automatic lane change will be performed on the curved road ahead of the travel path of the vehicle V. The automatic lane change according to the present embodiment is based on, for example, the request from the control device CNT. Details of this processing will be described later with reference to FIG. 7.

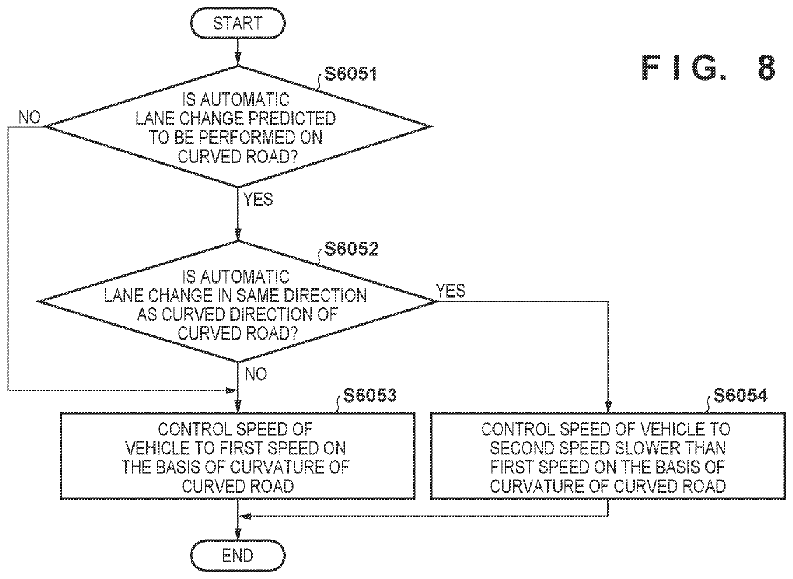

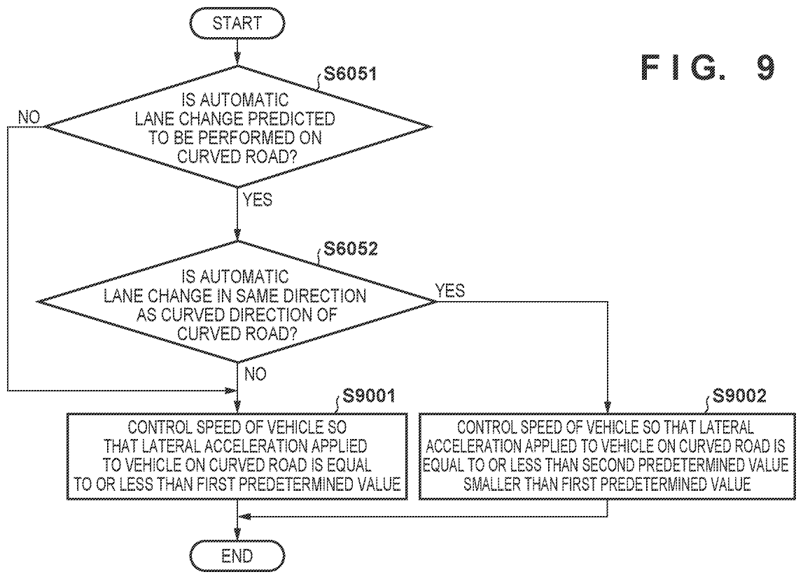

In S605, the ECU controls a speed of the vehicle Von the basis of a prediction result in S604 and the curvature of the curved road ahead of the travel path of the vehicle V. Details of this processing will be described later with reference to FIGS. 8 and 9. This is an end of a series of processing in FIG. 6.

<Prediction Processing>

FIG. 7 is a flowchart illustrating a specific example of prediction processing performed by the ECU included in the controller 1. This is an example of processing of S604 of FIG. 6.

In S6041, the ECU determines whether there is a preceding vehicle traveling in the same lane as the travel path of the vehicle V on the basis of the peripheral information of the vehicle V. When the preceding vehicle is present, the process proceeds to S6042. On the other hand, when the preceding vehicle is not present, the process proceeds to S6045.

In S6042, the ECU obtains information on a current speed of the vehicle V, and calculates a speed of the preceding vehicle and a distance (distance in a direction along the lane) between the vehicle V and the preceding vehicle on the basis of the peripheral information. Then, on the basis of the speed of the vehicle V, the speed of the preceding vehicle, and the distance between the vehicle V and the preceding vehicle, a possibility that the vehicle V will catch up with the preceding vehicle during traveling on the curved road ahead is determined.

In S6043, the ECU determines whether there is a possibility that the vehicle V will catch up with the preceding vehicle during traveling on the curved road ahead. If there is a possibility, the process proceeds to S6044. On the other hand, if there is no possibility, the process proceeds to S6045.

In S6044, the ECU predicts that the automatic lane change is performed on the curved road ahead. For example, the automatic lane change for overtaking may be performed to avoid a slow preceding vehicle.

In S6045, the ECU predicts that the automatic lane change is not performed on the curved road ahead. This step is performed when there is no preceding vehicle traveling in the same lane as the travel path of the vehicle V, or when there is no possibility that the vehicle will catch up with the preceding vehicle during traveling on the curved road on the basis of the speed of the preceding vehicle traveling in the same lane as the vehicle and the speed of the vehicle. This is an end of a series of processing in FIG. 7.

<Speed Control Processing: Determination of Speed of Vehicle V from Curvature of Curved Road>

FIG. 8 is a flowchart illustrating a specific example of speed control processing performed by the ECU included in the controller 1. This is an example of processing of S605 of FIG. 6.

In S6051, the ECU determines whether the automatic lane change is predicted to be performed on the curved road ahead of the vehicle V in S604. When it is predicted that the automatic lane change is performed, the process proceeds to S6052. On the other hand, when it is predicted that the automatic lane change is not performed, the process proceeds to S6053.

In S6052, the ECU determines whether it is the automatic lane change in the same direction as a curved direction of the curved road ahead. If this step is Yes, the process proceeds to S6054. On the other hand, if this step is No, the process proceeds to S6053. For example, when the curved road is a right curve and the vehicle V performs the automatic lane change to the same right direction, this step is Yes. Similarly, when the curved road is a left curve and the vehicle V performs the automatic lane change to the same left direction, this step is Yes. On the other hand, when the curved road is the right curve and the vehicle V performs the automatic lane change to the left direction which is an opposite direction, this step is No. Similarly, when the curved road is the left curve and the vehicle V performs the automatic lane change to the right direction which is an opposite direction, this step is No.

In S6053, the ECU controls the speed of the vehicle to a first speed on the basis of the curvature of the curved road ahead. For example, consider a case where the speed of the vehicle V before entering the curved road is 110 km/h and the curved road has a radius of 300 meters (300R). In this step, since the automatic lane change is not performed or the automatic lane change is performed in a direction opposite to the curved direction of the curved road ahead, the speed before entering the curved road does not need to be excessively reduced, and thus the first speed is set to, for example, 98.6 km/h.

In S6054, the ECU controls the speed of the vehicle to a second speed slower than the first speed on the basis of the curvature of the curved road ahead. Similarly, consider a case where the speed of the vehicle V before entering the curved road is 110 km/h and the curved road has the radius of 300 meters (300R). In this step, since the automatic lane change is performed in the same direction as the curved direction of the curved road ahead, unless the speed of the vehicle V is greatly reduced, large lateral acceleration is applied at the time of the automatic lane change, and it is difficult to achieve comfortable automated driving. Therefore, the second speed is set to, for example, 88.2 km/h. Thus, it is possible to prevent the large lateral acceleration from being applied when the automatic lane change is performed, so that it is possible to achieve the comfortable automated driving. This is an end of a series of processing in FIG. 8.

Note that table data in which the curvature of the curved road, the first speed of the vehicle V, and the second speed of the vehicle V are associated in advance may be held, and the first speed or the second speed may be determined using the table data on the basis of the curvature of the curved road. Thus, regardless of the current speed of the vehicle V, a target speed of the vehicle V can be appropriately controlled from the curvature of the curved road ahead.

<Modification of Speed Control Processing: Determination of Speed of Vehicle V from Target Lateral Acceleration and Curvature of Curved Road>

FIG. 9 is a flowchart illustrating a specific example of the speed control processing performed by the ECU included in the controller 1. This is an example of the processing of S605 of FIG. 6, and is a modification of FIG. 8. The same processing as that in FIG. 8 is denoted by the same reference numeral, and a description thereof will be omitted.

In S9001, the ECU controls the speed of the vehicle V so that the lateral acceleration applied to the vehicle V on the curved road ahead is equal to or less than a first predetermined value (for example, 2.5 m/S2). Similarly to the example of FIG. 8, consider a case where the speed of the vehicle V before entering the curved road is 110 km/h and the curved road has the radius of 300 meters (300R). The speed of vehicle V at which the lateral acceleration is the first predetermined value (for example, 2.5 m/S²) is 98.6 km/h. Therefore, the speed of the vehicle V is controlled to a value of 98.6 km/h or less.

In S9002, the ECU controls the speed of the vehicle V so that the lateral acceleration applied to the vehicle V on the curved road ahead is equal to or less than a second predetermined value (for example, 2.0 m/S²) smaller than the first predetermined value (for example, 2.5 m/S²). Similarly to the example of FIG. 8, consider a case where the speed of the vehicle V before entering the curved road is 110 km/h and the curved road has the radius of 300 meters (300R). The speed of vehicle V at which the lateral acceleration is the second predetermined value (for example, 2.0 m/S²) is 88.2 km/h. Therefore, the speed of the vehicle V is controlled to a value of 88.2 km/h or less. This is an end of a series of processing in FIG. 9.

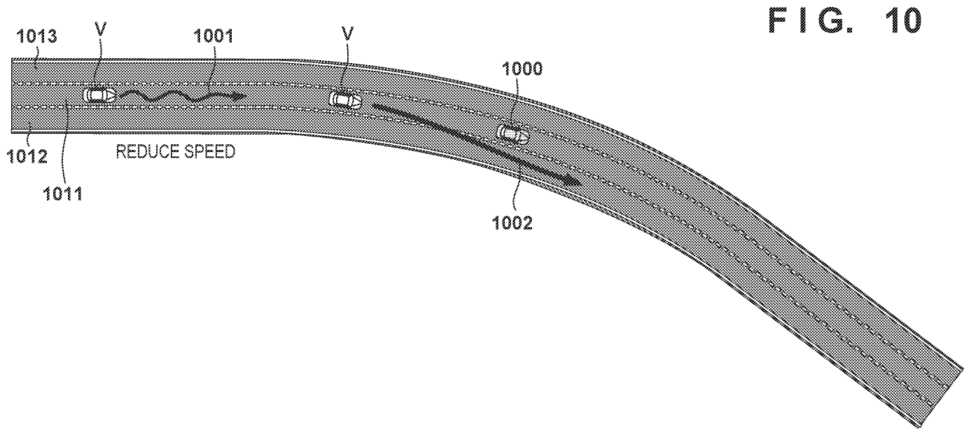

Here, with reference to FIG. 10, an example of a case will be described in which there is a preceding vehicle traveling in the same lane as the travel path of the vehicle V, there is a possibility that the speed of the preceding vehicle is slower than the speed of the vehicle V and the vehicle V will catch up with the preceding vehicle during traveling on the curved road ahead, and the automatic lane change in the same direction as the curved direction of the curved road ahead is predicted.

In FIG. 10, the vehicle Vis traveling in a travel lane 1011. There is an adjacent lane 1013 in the left direction of the vehicle V, and there is an adjacent lane 1012 in the right direction of the vehicle V. Then, there is a preceding vehicle 1000 ahead of the travel lane 1011, there is a possibility that the vehicle V will catch up with the preceding vehicle during traveling on the curved road ahead, and automatic lane change 1002 in the same direction (right direction) as the curved direction (right direction) of the curved road ahead is predicted.

In this case, in the process of FIG. 7, it is Yes in S6041, the process proceeds to S6043 through S6042, it is Yes in S6043, and the process proceeds to S6044. Then, in the process of FIG. 8, it is Yes in S6051, the process proceeds to S6052, it is Yes in S6052, and the process proceeds to S6054. Then, in S6054, as indicated by an arrow 1001 in FIG. 10, it is controlled to the second speed (for example, 88.2 km/h in the case of the current speed (110 km/h) of the vehicle V and the curvature (R300) of the curved road described in the examples of FIGS. 8 and 9) that is greatly reduced. Thereafter, the vehicle V enters the curved road, and performs the automatic lane change 1002 for overtaking on the curved road.

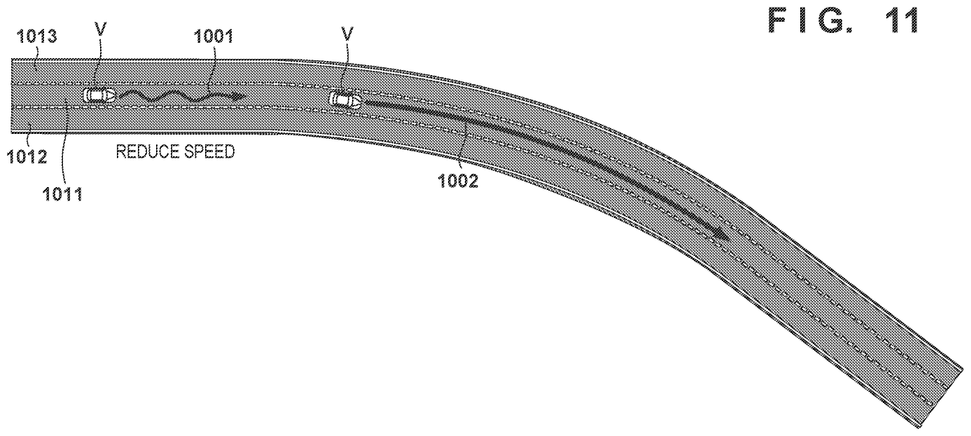

Next, with reference to FIG. 11, an example of a case will be described in which there is no preceding vehicle traveling in the same lane as the travel path of the vehicle V and the automatic lane change is not predicted. In FIG. 11, the vehicle V is traveling in a travel lane 1011. There is an adjacent lane 1013 in the left direction of the vehicle V, and there is an adjacent lane 1012 in the right direction of the vehicle V. Then, since there is no preceding vehicle of the vehicle V, the automatic lane change on the curved road ahead is not predicted.

In this case, in the processing of FIG. 7, it is No in S6041, and the process proceeds to S6045. Then, in the processing of FIG. 8, it is No in S6051, and the process proceeds to S6053. Then, in S6053, as indicated by an arrow 1101 in FIG. 11, it is controlled to the first speed (for example, 98.6 km/h in the case of the current speed (110 km/h) of the vehicle V and the curvature (R300) of the curved road described in the examples of FIGS. 8 and 9) that is reduced to some extent. Thereafter, the vehicle V enters the curved road, and continues to travel in the travel lane 1011.

As described above, in the present embodiment, it is predicted whether or not the automatic lane change will be performed on the curved road ahead of the travel path of the vehicle, and the speed of the vehicle is controlled on the basis of a prediction result thereof and the curvature of the curved road.

This makes it possible to perform adaptive speed control during traveling on the curved road. Since it is possible to achieve the adaptive speed control of the vehicle when the automatic lane change is performed on the curved road and when the automatic lane change is not performed, it is possible to achieve the comfortable automated driving. In particular, when it is predicted that the automatic lane change in the same direction as the curved direction of the curved road will be performed on the curved road, it is possible to prevent excessive lateral acceleration from being applied even if the automatic lane change is performed on the curved road by controlling deceleration to be relatively large before entering the curved road. In addition, when it is predicted that the automatic lane change in the same direction as the curved direction of the curved road will not be performed on the curved road, it is possible to prevent excessive deceleration by controlling deceleration to be relatively small before entering the curved road. Therefore, it is possible to achieve the comfortable automated driving.

[Modifications]

In the above embodiment, an example has been described in which whether or not the automatic lane change will be performed on the curved road is predicted in S604 of FIG. 6, but the present invention is not limited to this example. When the ECU further specifies that the lane marking of the travel path of the vehicle V indicates lane change prohibition on the basis of the peripheral information, the ECU may control to stop the prediction processing. In that case, the subsequent processing is performed assuming that there is no prediction result or assuming that it is predicted that the automatic lane change will not be performed on the curved road. Alternatively, configuration may be such that the prediction result is not used for speed control after the prediction processing is performed. In such a case, the ECU may be configured to control the speed of the vehicle V on the basis of the curvature of the curved road ahead. At this time, for example as described with reference to FIG. 11, the speed of the vehicle V can be determined in the same manner as a case where the automatic lane change is not performed.

In the above embodiment, an example has been described in which the ECU specifies the travel path of the vehicle V on the basis of the peripheral information and specifies the curved road ahead of the travel path, but the present invention is not limited to this example. For example, specification may be performed on the basis of the peripheral information and the map information (high-precision map). Thus, it is possible to perform specification with higher accuracy, so that safety of the automated driving can be further improved.

In the above embodiment, an example has been mainly described in which the automatic lane change for overtaking is predicted in consideration of the presence of the preceding vehicle of the vehicle V, but the present invention is not limited to this. For example, the ECU may predict whether or not the automatic lane change will be performed on the basis of the route guidance to the destination. Then, when it is predicted that the navigation system will request the lane change of the vehicle V on the curved road on the basis of a set route to the destination, the speed of the vehicle V may be controlled to a predetermined speed (not the second speed but the first speed in the example of FIG. 8) on the basis of the curvature of the curved road without performing the automatic lane change on the curved road. Then, the automatic lane change may be performed after the curved road ends. A possibility that the excessive lateral acceleration will be applied can be reduced by controlling so as not to perform the automatic lane change during traveling on the curved road. Therefore, it is possible to achieve the comfortable automated driving.

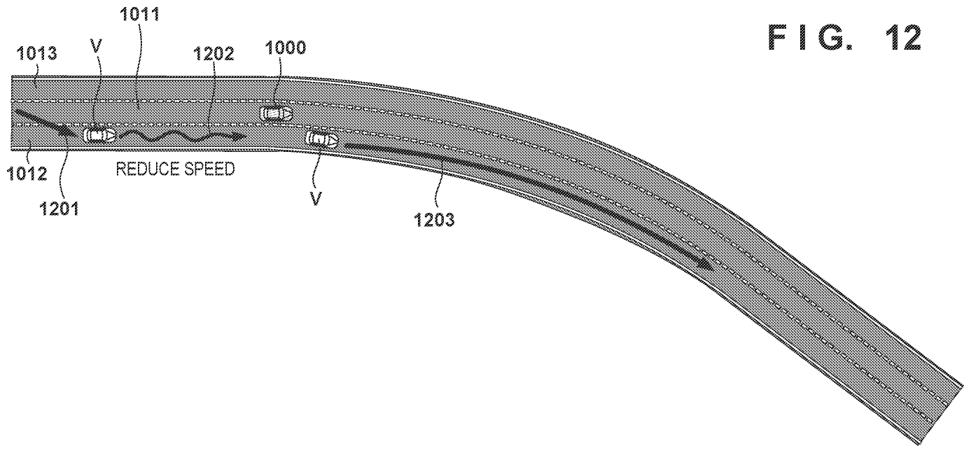

In addition, when it is predicted that the automatic lane change to return to an original lane on the curved road (so-called overtaking and return) will be performed after overtaking the preceding vehicle traveling in the same lane as the vehicle V, the speed of the vehicle V may be controlled to the predetermined speed (not the second speed but the first speed in the example of FIG. 8) on the basis of the curvature of the curved road without performing the automatic lane change to return to the original lane on the curved road. Then, the automatic lane change to return to the original lane may be performed after the curved road ends. For example, as illustrated in FIG. 12, before entering the curved road, automatic lane change 1201 is performed in order to overtake the preceding vehicle 1000, and the vehicle moves from the travel lane 1011 to a travel lane 1012. Then, the vehicle decelerates as indicated by an arrow 1202 before entering the curved road, continues to travel in the travel lane 1012, and performs the automatic lane change to return to the original lane after the curved road ends.

Thus, it is possible to prevent the large lateral acceleration from being applied on the curved road because the automatic lane change is not performed. In addition, the excessive deceleration on the curved road can be prevented. Therefore, it is possible to achieve the comfortable automated driving.

Further, in the above embodiment, the automatic lane change (ALC) based on the request from the control device CNT has been described as an example. On the other hand, in the automatic lane change, the automatic lane change (ALCA) based on a request from the user can also be performed. In response to an operation of a switch (for example, the direction indicator lever 6b) that receives an execution instruction of the automatic lane change based on the request from the user, the automatic lane change can be performed.

When the switch (for example, the direction indicator lever 6b) is operated and the automatic lane change based on the request from the user is performed on the curved road, the ECU may control the speed of the vehicle to the predetermined speed (not the second speed but the first speed in the example of FIG. 8) on the basis of the curvature of the curved road without performing the automatic lane change (ALCA) on the curved road. Then, the automatic lane change (ALCA) may be performed after the curved road ends.

Thus, it is possible to prevent the large lateral acceleration from being applied on the curved road because the automatic lane change is not performed. In addition, the excessive deceleration on the curved road can be prevented. Therefore, it is possible to achieve the comfortable automated driving.

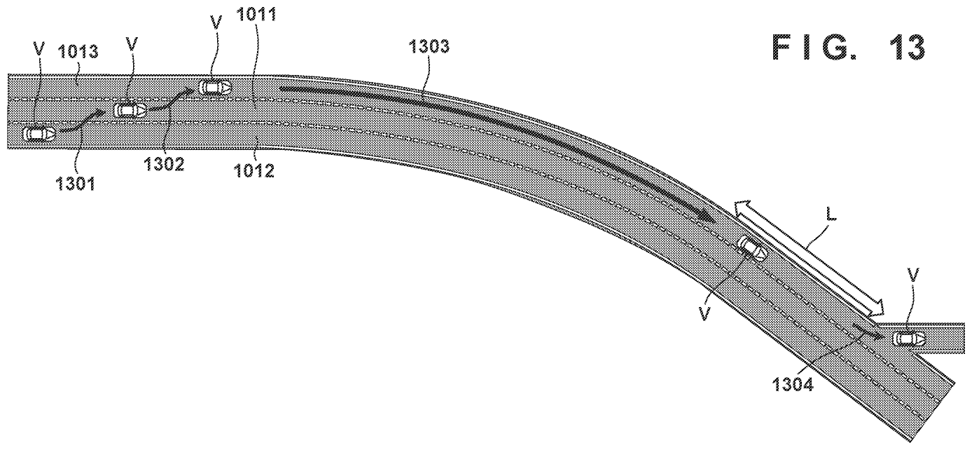

In addition, consider a case where there is the curved road ahead of the vehicle V, and there is a branch road within a predetermined distance after the curved road ends, and it is necessary to change a course to the branch road according to route guidance. FIG. 13 is an explanatory diagram of such a case.

In FIG. 13, the vehicle V needs to change course to the branch road as indicated by an arrow 1304 after the curved road ends. When this can be predicted from a route plan in advance, according to a distance L (a distance of a straight route) from an end point of the curved road to an entrance of the branch road, it is controlled whether to perform the automatic lane change to a travel lane connected to the branch road before entering the curved road or to perform the automatic lane change to the travel lane connected to the branch road after an end of travel on the curved road.

For example, when the distance L of the straight route from the end point of the curved road to the branch road is equal to or less than a prescribed distance, it is determined that the automatic lane change is performed in advance to the travel lane connected to the branch road before entering the curved road. On the other hand, when the distance L of the straight route from the end point of the curved road to the branch road is longer than the prescribed distance, it is determined that the automatic lane change to the travel lane connected to the branch road is performed after the end of travel on the curved road.

In the example of FIG. 13, it is determined that the distance L of the straight route from the end point of the curved road to the branch road is equal to or less than the prescribed distance, and the automatic lane change is performed in advance to the travel lane connected to the branch road before entering the curved road so that it is easy to change course to the branch road. In the illustrated example, the vehicle V traveling in the travel lane 1012 moves to the travel lane 1011 by performing automatic lane change 1301, further moves to a travel lane 1013 by performing automatic lane change 1302, and is controlled (decelerated) to the predetermined speed (not the second speed but the first speed in the example of FIG. 8). Thus, it is possible to travel on the curved road without performing the automatic lane change as indicated by an arrow 1303. Then, after the curved road ends, the course is changed to the branch road as indicated by an arrow 1304.

On the other hand, when the distance L of the straight route from the end point of the curved road to the branch road is longer than the prescribed distance, the vehicle V traveling in the travel lane 1012 travels on the curved road while continuing to travel in the same travel lane, performs the automatic lane change after the end point of the curved road to move to the travel lane 1011 and further to the travel lane 1013, and changes the course to the branch road as indicated by the arrow 1304.

Thus, it is possible to prevent the large lateral acceleration from being applied on the curved road because the automatic lane change is not performed during traveling on the curved road. In addition, the excessive deceleration on the curved road can be prevented. Therefore, it is possible to achieve the comfortable automated driving.

<Summary of Embodiment>

The control device (CNT) according to a first aspect is a control device that controls a vehicle (V), the control device comprising:
an obtaining unit (1, 8a, 8b, S601) configured to obtain peripheral information of the vehicle;
a specifying unit (1, S602, S603) configured to specify a travel path of the vehicle and a curved road ahead of the travel path of the vehicle on the basis of the peripheral information;
a prediction unit (1, S604) configured to predict whether or not automatic lane change is performed on the curved road; and
a control unit (1, S605) configured to control a speed of the vehicle on the basis of a prediction result of the prediction unit and a curvature of the curved road.

This makes it possible to perform adaptive speed control during traveling on the curved road. Since it is possible to achieve the adaptive speed control of the vehicle when the automatic lane change is performed on the curved road and when the automatic lane change is not performed, it is possible to achieve the comfortable automated driving. In addition, it is possible to suppress reduction in smoothness of traffic while improving traffic safety.

In the control device (CNT) according to a second aspect, when it is not predicted that the automatic lane change is performed to the same direction as a curved direction of the curved road, the control unit controls the speed of the vehicle to a first speed on the basis of the curvature of the curved road (S6053), and
when it is predicted that the automatic lane change is performed to the same direction as the curved direction of the curved road, the control unit controls the speed of the vehicle to a second speed slower than the first speed on the basis of the curvature of the curved road (S6054).

Thus, when the automatic lane change is performed in the same direction as the curved direction during traveling on the curved road, the vehicle travels at a relatively low speed, so that it is possible to prevent the excessive lateral acceleration from being applied. In addition, when the automatic lane change is not performed in the same direction as the curved direction during traveling on the curved road, the vehicle travels at a relatively high speed, so that it is possible to avoid unnecessary deceleration, and to travel according to surrounding traffic flow.

In the control device (CNT) according to a third aspect, when it is not predicted that the automatic lane change is performed to the same direction as a curved direction of the curved road, the control unit controls the speed of the vehicle so that a lateral acceleration applied to the vehicle on the curved road is equal to or less than a first predetermined value (for example, 2.5 m/S²) on the basis of the curvature of the curved road (S9001), and
when it is predicted that the automatic lane change is performed to the same direction as the curved direction of the curved road, the control unit controls the speed of the vehicle so that the lateral acceleration applied to the vehicle on the curved road is equal to or less than a second predetermined value (for example, 2.0 m/S²) smaller than the first predetermined value on the basis of the curvature of the curved road (S9002).

In this way, when it is predicted that the automatic lane change will be performed in the same direction as the curved direction during traveling on the curved road, the speed of the vehicle is controlled using a relatively small lateral acceleration as a reference value in preparation for a case where the automatic lane change is performed. Thus, it is possible to control the speed to be relatively small. In addition, when the automatic lane change is not performed in the same direction as the curved direction during traveling on the curved road, the vehicle travels at a relatively high speed, so that it is possible to avoid unnecessary deceleration, and to travel according to surrounding traffic flow.

In the control device (CNT) according to a fourth aspect, the automatic lane change is automatic lane change (ALC) based on a request from the control device.

Thus, it is possible to achieve adaptive ALC during traveling on the curved road, so that it is possible to achieve the comfortable automated driving.

In the control device (CNT) according to a fifth aspect, the specifying unit can further specify that a lane marking of the travel path of the vehicle indicates lane change prohibition on the basis of the peripheral information, and
the prediction unit stops prediction processing when it is specified that the lane marking of the travel path of the vehicle indicates the lane change prohibition.

Thus, it is not necessary to perform unnecessary processing when there is no possibility of the automatic lane change in the first place, so that a processing load can be reduced.

In the control device (CNT) according to a sixth aspect, the specifying unit performs specification on the basis of the peripheral information and map information.

This makes it possible to specify the travel path of the vehicle and the curved road ahead of the vehicle with higher accuracy.

In the control device (CNT) according to a seventh aspect, the prediction unit predicts that the automatic lane change is performed when a speed of a preceding vehicle traveling in the same lane as the vehicle is slower than the speed of the vehicle and there is a possibility that the vehicle will catch up with the preceding vehicle during traveling on the curved road (S6043, S6044).

This makes it possible to perform the automatic lane change for overtaking at an appropriate speed during traveling on the curved road.

In the control device (CNT) according to an eighth aspect, the prediction unit determines a possibility that the vehicle will catch up with the preceding vehicle during traveling on the curved road on the basis of the speed of the vehicle and the speed of the preceding vehicle, and a distance between the vehicle and the preceding vehicle before entering the curved road (S6042).

This makes it possible to perform the adaptive speed control before entering the curved road.

In the control device (CNT) according to a ninth aspect, the prediction unit predicts that the automatic lane change is not performed when there is no possibility that the vehicle will catch up with a preceding vehicle during traveling on the curved road from the speed of the preceding vehicle traveling in the same lane as the vehicle and the speed of the vehicle (No in S6043, S6045).

This makes it possible to perform the adaptive speed control when there is no possibility of catching up with the preceding vehicle.

In the control device (CNT) according to a tenth aspect, the prediction unit predicts that the automatic lane change is not performed when there is no preceding vehicle traveling in the same lane as the vehicle (No in S6041, S6045).

This makes it possible to perform the adaptive speed control when there is no preceding vehicle.

In the control device (CNT) according to an eleventh aspect, the prediction unit predicts whether or not the automatic lane change is performed on the basis of route guidance to a destination, and
when the prediction unit predicts that the automatic lane change is performed according to the route guidance on the curved road and course change to a branch road is performed after an end of the curved road, and if a distance (L) from an end point of the curved road to the branch road is longer than a prescribed distance, the control unit does not perform the automatic lane change on the curved road and controls the speed of the vehicle to a predetermined speed on the basis of the curvature of the curved road, and performs the automatic lane change after the curved road ends.

This makes it possible to prevent the excessive lateral acceleration from being applied during traveling on the curved road.

In the control device (CNT) according to a twelfth aspect, when the prediction unit predicts that the automatic lane change is performed according to the route guidance on the curved road and the course change to the branch road is performed after the end of the curved road, and if the distance (L) from the end point of the curved road to the branch road is equal to or less than the prescribed distance, the control unit performs the automatic lane change before entering the curved road.

This makes it possible to prevent the excessive lateral acceleration from being applied during traveling on the curved road.

In the control device (CNT) according to a thirteenth aspect, when the prediction unit predicts that the automatic lane change to return to an original lane on the curved road is performed after overtaking a preceding vehicle traveling in the same lane as the vehicle, the control unit does not perform the automatic lane change to return to the original lane on the curved road and controls the speed of the vehicle to a predetermined speed on the basis of the curvature of the curved road, and performs the automatic lane change to return to the original lane after the curved road ends (FIG. 12).

Thus, it is possible to perform return processing after overtaking at an appropriate timing, so that it is possible to enhance a sense of safety of the occupant.

The control device (CNT) according to a fourteenth aspect, further comprising
a switch (6B) that receives an execution instruction of the automatic lane change (ALCA) based on a request from a user, wherein
when the switch is operated and the automatic lane change based on the request from the user is performed, the control unit does not perform the automatic lane change on the curved road and controls the speed of the vehicle to a predetermined speed on the basis of the curvature of the curved road, and performs the automatic lane change after the curved road ends.

Thus, it is possible to perform the ALCA at an appropriate timing according to a situation, so that it is possible to enhance a sense of safety of the occupant.

The method for operating a control device (CNT) according to a fifteenth aspect is a method for operating a control device for controlling a vehicle, the method comprising:
an obtaining step (S601) of obtaining peripheral information of the vehicle;
a specifying step (S602, S603) of specifying a travel path of the vehicle and a curved road ahead of the travel path of the vehicle on the basis of the peripheral information;
a prediction step (S604) of predicting whether or not automatic lane change is performed on the curved road; and
a control step (S605) of controlling a speed of the vehicle on the basis of a prediction result in the prediction step and a curvature of the curved road.

This makes it possible to perform adaptive speed control during traveling on the curved road. Since it is possible to achieve the adaptive speed control of the vehicle when the automatic lane change is performed on the curved road and when the automatic lane change is not performed, it is possible to achieve the comfortable automated driving. In addition, it is possible to suppress reduction in smoothness of traffic while improving traffic safety.

The storage medium according to a sixteenth aspect is a non-transitory computer-readable storage medium storing a program for causing a computer to function as the control device according to any one of the first aspect to fourteenth aspect.

Thus, processing of the control device can be implemented by the non-transitory computer-readable storage medium.

According to the present invention, it is possible to perform the adaptive speed control during traveling on the curved road. Therefore, it is possible to suppress reduction in the smoothness of the traffic while improving the traffic safety.

The invention is not limited to the foregoing embodiments, and various variations/changes are possible within the spirit of the invention.

What is claimed is:

1. A control device that controls a vehicle, the control device comprising:
an obtaining unit configured to obtain peripheral information of the vehicle;
a specifying unit configured to specify a travel path of the vehicle and a curved road ahead of the travel path of the vehicle on the basis of the peripheral information;
a prediction unit configured to predict whether or not automatic lane change is performed on the curved road; and
a control unit configured to control a speed of the vehicle on the basis of a prediction result of the prediction unit and a curvature of the curved road.

2. The control device according to claim 1, wherein when it is not predicted that the automatic lane change is performed to the same direction as a curved direction of the curved road,
the control unit controls the speed of the vehicle to a first speed on the basis of the curvature of the curved road, and
when it is predicted that the automatic lane change is performed to the same direction as the curved direction of the curved road, the control unit controls the speed of the vehicle to a second speed slower than the first speed on the basis of the curvature of the curved road.

3. The control device according to claim 1, wherein when it is not predicted that the automatic lane change is performed to the same direction as a curved direction of the curved road,
the control unit controls the speed of the vehicle so that a lateral acceleration applied to the vehicle on the curved road is equal to or less than a first predetermined value on the basis of the curvature of the curved road, and
when it is predicted that the automatic lane change is performed to the same direction as the curved direction of the curved road, the control unit controls the speed of the vehicle so that the lateral acceleration applied to the vehicle on the curved road is equal to or less than a second predetermined value smaller than the first predetermined value on the basis of the curvature of the curved road.

4. The control device according to claim 1, wherein the automatic lane change is automatic lane change based on a request from the control device.

5. The control device according to claim 1, wherein the specifying unit can further specify that a lane marking of the travel path of the vehicle indicates lane change prohibition on the basis of the peripheral information, and
the prediction unit stops prediction processing when it is specified that the lane marking of the travel path of the vehicle indicates the lane change prohibition.

6. The control device according to claim 1, wherein the specifying unit performs specification on the basis of the peripheral information and map information.

7. The control device according to claim 1, wherein the prediction unit predicts that the automatic lane change is performed when a speed of a preceding vehicle traveling in the same lane as the vehicle is slower than the speed of the vehicle and there is a possibility that the vehicle will catch up with the preceding vehicle during traveling on the curved road.

8. The control device according to claim 7, wherein the prediction unit determines a possibility that the vehicle will catch up with the preceding vehicle during traveling on the curved road on the basis of the speed of the vehicle and the speed of the preceding vehicle, and a distance between the vehicle and the preceding vehicle before entering the curved road.

9. The control device according to claim 1, wherein the prediction unit predicts that the automatic lane change is not performed when there is no possibility that the vehicle will catch up with a preceding vehicle during traveling on the curved road from the speed of the preceding vehicle traveling in the same lane as the vehicle and the speed of the vehicle.

10. The control device according to claim 1, wherein the prediction unit predicts that the automatic lane change is not performed when there is no preceding vehicle traveling in the same lane as the vehicle.

11. The control device according to claim 1, wherein the prediction unit predicts whether or not the automatic lane change is performed on the basis of route guidance to a destination, and
when the prediction unit predicts that the automatic lane change is performed according to the route guidance on the curved road and course change to a branch road is performed after an end of the curved road, and if a distance from an end point of the curved road to the branch road is longer than a prescribed distance, the control unit does not perform the automatic lane change on the curved road and controls the speed of the vehicle to a predetermined speed on the basis of the curvature of the curved road, and performs the automatic lane change after the curved road ends.

12. The control device according to claim 11, wherein when the prediction unit predicts that the automatic lane change is performed according to the route guidance on the curved road and the course change to the branch road is performed after the end of the curved road, and if the distance from the end point of the curved road to the branch road is equal to or less than the prescribed distance, the control unit performs the automatic lane change before entering the curved road.

13. The control device according to claim 1, wherein when the prediction unit predicts that the automatic lane change to return to an original lane on the curved road is performed after overtaking a preceding vehicle traveling in the same lane as the vehicle, the control unit does not perform the automatic lane change to return to the original lane on the curved road and controls the speed of the vehicle to a predetermined speed on the basis of the curvature of the curved road, and performs the automatic lane change to return to the original lane after the curved road ends.

14. The control device according to claim 1, further comprising
a switch that receives an execution instruction of the automatic lane change based on a request from a user, wherein
when the switch is operated and the automatic lane change based on the request from the user is performed, the control unit does not perform the automatic lane change on the curved road and controls the speed of the vehicle to a predetermined speed on the basis of the curvature of the curved road, and performs the automatic lane change after the curved road ends.

15. A method for operating a control device for controlling a vehicle, the method comprising:
an obtaining step of obtaining peripheral information of the vehicle;
a specifying step of specifying a travel path of the vehicle and a curved road ahead of the travel path of the vehicle on the basis of the peripheral information;
a prediction step of predicting whether or not automatic lane change is performed on the curved road; and
a control step of controlling a speed of the vehicle on the basis of a prediction result in the prediction step and a curvature of the curved road.

16. A non-transitory computer-readable storage medium storing a program for causing a computer to function as the control device according to claim 1.
